(19) United States
(12) Patent Application Publication
(10) Pub. No.: US 2014/0261283 A1
(43) Pub. Date: Sep. 18, 2014

(54) PISTON AND METHOD OF MAKING A PISTON

(71) Applicant: FEDERAL-MOGUL CORPORATION, Southfield, MI (US)

(72) Inventors: Warran Boyd Lineton, Ann Arbor, MI (US); Greg Salenbien, Britton, MI (US)

(73) Assignee: Federal-Mogul Corporation, Southfield, MI (US)

(21) Appl. No.: 13/826,813

(22) Filed: Mar. 14, 2013

(51) Int. Cl. F02F 3/00

(52) U.S. Cl. CPC F02F 3/00
USPC 123/193.6; 29/888.05

(57) ABSTRACT

A piston for an internal combustion engine is provided. The piston includes a pair of pin bosses formed of aluminum or an aluminum alloy spaced from one another in an axial direction. Each of the pin bosses has a generally circular opening for receiving a wrist pin. The pin bosses are formed integrally with surrounding areas of the piston, and each pin boss has a zone with increased hardness relative to the surrounding areas of the piston. The zone with increased hardness is at the inner periphery of the generally circular opening and resists deformation from forces between the piston and a wrist pin during operation of the internal combustion engine. Preferably, the zone with increased hardness has a dendritic microstructure with primary silicon crystallites dispersed throughout; are substantially free of pores and cracks; and have a Vickers Hardness Value of between 169 and 177.

### BACKGROUND OF THE INVENTION

1. Field of the Invention

The present invention is related generally to pistons for internal combustion engines.

2. Related Art

Monobloc aluminum pistons for use with internal combustion engines generally include a crown portion, a pair of skirt portions and a pair of pin bosses all formed as one piece. The pin bosses of such pistons are aligned axially with one another, and when the piston is installed in an engine, a wrist pin extends between and is supported by the aligned pin bosses. The wrist pin couples the piston with a connecting rod which transfers mechanical power from the piston to a crankshaft during operation of the engine. The pin bosses of typical monobloc aluminum pistons, which are usually formed through conventional casting or forging processes, are generally too soft to directly support the wrist pin without deforming during operation of the engine, i.e. the pin bosses may deform under the contact forces between the piston and the wrist pin during operation of the engine. Accordingly, most piston manufacturers install a separate bushing of a harder material into each of the pin bosses to reduce the risk of deformation of the pin bosses during operation of the engine. However, the bushings increase the material cost of the piston, and the process of pressing the bushings into the pin bosses may be time consuming and/or laborious.

### SUMMARY OF THE INVENTION

One aspect of the present invention provides for a piston for an internal combustion engine including a pair of pin bosses formed of aluminum or an aluminum alloy which are hardened relative to the surrounding portions to directly support a wrist pin without deformation during operation of an engine. Specifically, each of the pin bosses presents a zone with increased hardness relative to the surrounding portions of the piston at an inner periphery of the generally circular opening for directly supporting the wrist pin without an intermediate bushing. This leads to cost savings as compared to conventional aluminum pistons with bushings. Preferably, the hardened zones have a dendritic microstructure with primary silicon crystallites dispersed throughout; are substantially free of pores and cracks; and have a Vickers Hardness Value of between 169 and 177.

Another aspect of the present invention provides for a method of making a piston. The method includes the step of preparing a piston body of aluminum or an aluminum alloy and having a pair of pin bosses spaced from one another in an axial direction. Each of the pin bosses presents a generally circular shaped opening for receiving a wrist pin. The method proceeds with melting at least a portion of the inner periphery of at least one of the pin bosses with a laser beam and cooling the melted region. This process alters the microstructure of the piston body at the inner periphery of the pin boss such that it is harder than the surrounding portions of the piston body, thereby allowing the pin bosses to directly support a wrist pin without an intermediate bushing. This process may be carried out very quickly and cost effectively. Additionally, quenching in air or shield gas is sufficient to establish the desired microstructure, so a separate cooling process is not required.

According to yet another aspect of the present invention, the method additionally includes the step of rotating the piston body and reflecting the laser beam in a vertically downward direction such that the portion of the at least one pin boss being melted is substantially the lower-most portion of the at least one pin boss during the rotation of the piston body. This is advantageous because the melt pool is not able to flow downwardly from gravity.

According to still another aspect of the present invention, an apparatus for hardening an inner diameter of an aluminum or aluminum alloy pin boss in a piston body is provided. The apparatus includes a rotary chuck for supporting and rotating the piston body, a laser for emitting laser beam in a direction towards the pin boss and a reflector oriented to reflect the laser beam against the inner diameter of the pin boss to melt at least a portion of the inner diameter of the pin boss. This apparatus is able to quickly and efficiently reinforce harden portions of the pin bosses of piston bodies so that they may directly engage a wrist pin and resist deformation from forces between the piston body and the wrist pin during operation of an engine. Additionally, with little or no changes to the apparatus, the pin bosses of differently sized or shaped pistons may be hardened.

### BRIEF DESCRIPTION OF THE DRAWINGS

These and other features and advantages of the present invention will be readily appreciated, as the same becomes better understood by reference to the following detailed description when considered in connection with the accompanying drawings wherein:

FIG. 1 is a perspective view of an apparatus for hardening an inner diameter of a pin boss of an aluminum piston body;

FIG. 2 is a cross-sectional view of the piston of FIG. 1 with a portion of its pin boss being heated with a laser beam;

FIG. 3 is a perspective view of an exemplary aluminum piston body with hardened pin bosses; and

FIG. 4 is a cross-sectional view of the piston body of FIG. 2 taken along line 4-4 of FIG. 3.

### DESCRIPTION OF THE ENABLING EMBODIMENTS

One aspect of the present invention is an apparatus 20 for hardening an inner periphery of an opening of a pin boss 22. More precisely, the apparatus 20 according to this aspect of the present invention is configured to harden the inner peripheries of a pair of pin bosses 22 in a pre-formed aluminum or aluminum alloy piston body (such as the piston body 24 shown in FIG. 2) in a very quick and cost effective manner so that the pin bosses 22 may directly support a wrist pin (not shown) without an intermediate bushing as is typical for aluminum pistons. In operation, the apparatus 20 re-melts at least a portion of the inner periphery of one of the pin bosses 22. Upon cooling through air quenching in the ambient atmosphere or, optionally, in a shieling gas, the re-melted portions of the pin bosses 22 solidify with a greater hardness than the surrounding portions of the piston body 24 to create one or more zones 25 of increased hardness (best shown in FIG. 4). The zone or zones 25 of increased hardness resist deformation when transferring forces between the piston body 24 and the wrist pin during operation of the engine. In the exemplary embodiment, the hardened zones 25 have a dendritic microstructure with primary silicon crystallites dispersed throughout; are substantially free of pores and cracks; and have a Vickers Hardness Value of between 169 and 177.

Referring to FIG. 1, the apparatus 20 of the exemplary embodiment includes a stationary diode laser head 26 (or any other type of laser) which is oriented to emit a laser beam 28 with a generally rectangular cross-section into a generally horizontal direction which is generally parallel to the ground and perpendicular to gravity. The apparatus 20 also includes a rotary chuck 30 which is configured to engage a piston body 24 and to rotate the piston body 24 about an axis which runs through the openings in the pin bosses 22. In place of the rotary chuck 30, it should be appreciated that the apparatus 20 could include any suitable machine capable of engaging and rotating the piston body 24 about the axis. The rotary chuck 30 and diode laser stack 26 are positioned relative to one another such that diode laser stack 26 is aimed at approximately the axis of rotation, i.e. the diode laser head 26 is aimed to emit a laser beam through the centers of the aligned openings of the pin bosses 22. As best shown in FIG. 2, a copper mirror 32, or any other object with a reflective surface, is positioned adjacent the rotary chuck 30 and within one of the pin bosses 22 when the piston body 24 is engaged by the rotary chuck 30. The exemplary mirror 32 is oriented at approximately a forty-five degree (45°) angle relative to the horizontal direction such that it redirects or reflects the laser beam 28 emitted by the diode laser stack 26 into a substantially vertically downward direction.

During operation of the apparatus 20, the diode laser head 26 is activated and the laser beam 28 is reflected off of the copper mirror 32 in the direction of a lower-most portion of the inner diameter of the pin boss 22 to melt only that portion of the pin boss 22. This location is advantageous because gravity cannot pull the molten aluminum or aluminum alloy downwardly any further. During the melting of the lower-most portion of the inner diameter, the rotary chuck 30 is rotated at a predetermined and generally constant rotational velocity or speed through at least one entire revolution to re-melt substantially the entire inner periphery of the pin boss 22. Among other things, the speed of the rotary chuck 30, the power of the diode laser stack 26, the focal point of the laser beam 28 and the shape of the laser beam 28 may all be varied to adjust the depth of the remelted zone of the aluminum or aluminum alloy material. Preferably, these parameters are selected to remelt the material at the depth of between 1.1 and 1.7 mm.

Another aspect of the present invention is a method of making an aluminum or aluminum alloy piston body 24 with hardened pin bosses 22 for directly supporting a wrist pin without a bushing and resistant to deformation from forces between the piston body 24 and the wrist pin during operation of an engine. The exemplary method includes the step of preparing a piston body 24 having a pair of pin bosses 22 of aluminum or an aluminum alloy and extending in an axial direction. Each pin boss 22 also has an inner periphery which encircles and opening for receiving the wrist pin. In the exemplary embodiment shown in FIG. 3, the pin bosses 22 are part of a larger monobloc piston body 24 having a crown portion 34, a pair of skirt portions 36 and a pair of pin boss bridge portions 37 all integrally connected with one another. However, it should be appreciated that other piston designs could alternately be employed.

The exemplary method continues with the step of applying a light absorbing coating 38 (best shown in FIG. 1) over the inner peripheries of the pin bosses 22. The light absorbing coating 38 could be, for example, ink of a dark color from a marker or paint, and is configured to reduce the amount of light that is reflected off of the inner surfaces of the pin bosses 22.

The exemplary method then proceeds with the step of emitting a laser beam 28 having a generally rectangular profile in a generally horizontal direction (i.e. perpendicular to gravity) and reflecting the laser beam 28 by approximately ninety degrees (90°) with a copper mirror 32 into a vertically downward direction (i.e. parallel with gravity). The mirror 32 is preferably placed within the circular opening of one of the pin bosses 22 and oriented at a forty-five degree (45°) angle relative to the horizontal direction. As such, the reflected laser beam 28 contacts the lower-most portion of the inner diameter of the pin boss 22. In the exemplary method, the laser beam 28 has a wavelength of approximately eight hundred and eight nanometers (808 nm) and has a generally rectangularly shaped profile and is emitted by a diode laser stack 26 with approximately four kilowatts (4 kw) of power and a focus of approximately twelve by one half millimeters (12 mm×0.5 mm). These parameters have been found to melt the inner periphery of the aluminum or aluminum alloy pin bosses 22 to a depth of approximately one to two millimeters (1 mm-2 mm) and most preferably to a depth of approximately 1.1-1.7 mm.

During the melting step the method continues with the step of rotating the piston body 24 (for example, with a rotary chuck 30) about an axis which extends in the horizontal direction through at least one full revolution. Specifically, the axis extends through the centers of the openings in the pin bosses 22. As such, the laser beam 28 remains generally stationary and the piston body 24 rotates so that substantially the entire inner periphery of one of the pin bosses 22 may be re-melted. As the re-melted portions of the pin boss 22 rotate away from the reflected laser beam 28, they cool and solidify in the ambient air with a different microstructure and an increased hardness as compared to the surrounding portions of the piston body 24. Because the laser beam 28 contacts the lower-most portion of the inner periphery of the pin boss 22, the melt pool does not flow out of the treated zone via gravity before solidification takes place, i.e. the melt pool remains in the lower-most portion of the inner periphery. As such, the hardened zone 25 has a generally uniform thickness around the opening. Depending on the length of the pin boss 22 and the width of the laser beam 28, it may be necessary to rotate the pin boss 22 through more than one full revolution while either moving the piston body 24 and/or the mirror 32 axially between rotations so that the entire length of the inner periphery of the pin boss 22 may be re-melted. After the re-melting and cooling processes are completed, it may be desirable to smooth and finish the inner surface of the pin boss 22. The above-described steps may then be repeated for the other pin boss 22 so that both pin bosses 22 are hardened. The hardened zones 25 preferably have a dendritic microstructure with primary silicon crystallites dispersed throughout; are substantially free of pores and cracks; and have a Vickers Hardness Value of between 169 and 177.

The re-melting process may be carried out in atmospheric air or in a shield gas without the need for additional cooling. As such, the re-melting and cooling processes may be carried out very quickly and cost effectively. This provides for cost savings as compared to conventional aluminum pistons which require a separate bushing to be installed into the openings of the pin bosses to support the wrist pin. Rather than re-melting and cooling the entire inner periphery, the laser head 26 could be synchronized with the rotary chuck 30 to only re-melt selective zones of the inner periphery of the pin boss 22.

An exemplary piston body 24 having pin bosses 22 which were hardened according to the above-described method using the above-described apparatus 20 is generally shown in FIG. 3. The exemplary piston body 24 is a heavy duty aluminum alloy piston for use with diesel fueled internal combustion engines. The piston body 24 is of a monobloc design, i.e. it is of one integral piece of material and has a pair of skirt portions 36 and a pair of pin bosses 22 that are non-articulatedly coupled to a crown portion 34. The pin bosses 22 are spaced axially from one another and each has a generally circular opening for receiving a wrist pin (not shown) to couple the piston body 24 with a connecting rod (not shown) of the engine (not shown).

Referring now to the cross-sectional view of FIG. 4, the pin bosses 22 of the exemplary piston body 24 have a zone 25 with increased hardness compared to the surrounding portions of the piston body 24. The hardened zones 25 of the exemplary piston extend along substantially the entire inner periphery or the inner diameter of the pin bosses 22 to allow the aluminum alloy piston body 24 to directly support a wrist pin (not shown) without an intermediate bushing as is common with other known aluminum pistons. The hardened zones 25 have a different microstructure than the surrounding portions of the piston body 24 and are preferably between 1.1 and 1.7 mm in thickness.

Obviously, many modifications and variations of the present invention are possible in light of the above teachings and may be practiced otherwise than as specifically described while within the scope of the appended claims.

What is claimed is:

1. A piston for an internal combustion engine, comprising:
a pair of pin bosses formed of aluminum or an aluminum alloy;
said pin bosses being spaced from one another in an axial direction and each presenting a generally circular opening for receiving a wrist pin; and
each of said pin bosses being formed integrally with surrounding areas of said piston body presenting a zone with increased hardness relative to said surrounding areas of said piston at an inner periphery of said generally circular opening for resisting deformation from forces between said piston and a wrist pin during operation of the internal combustion engine.

2. The piston as set forth in claim 1 wherein said zone with increased hardness has a thickness of between 1.1 and 1.7 mm.

3. The piston as set forth in claim 1 wherein said zone with increased hardness has a dendritic microstructure with primary silicon crystallites dispersed throughout.

4. The piston as set forth in claim 1 wherein said zone with increased hardness is substantially free of pores and cracks and has a Vickers Hardness Value of between 169 and 177.

5. The piston as set forth in claim 1 further including a crown portion and a skirt portion formed integrally with said pin bosses.

6. The piston as set forth in claim 1 wherein said zones with increased hardness substantially entirely encircle said openings of said pin bosses.

7. The piston as set forth in claim 1 wherein said zones with increased hardness have a different microstructure than said surrounding areas of said piston.

8. A method of making a piston, comprising the steps of:
preparing a piston body of aluminum or an aluminum alloy and having a pair of pin bosses spaced from one another in an axial direction and wherein each pin boss presents a generally circular opening for receiving a wrist pin;
melting at least a portion of the inner periphery of at least one of the pin bosses with a laser beam; and
cooling the melted region to harden at least a portion of the at least one pin boss for resisting deformation from forces between the piston body and a wrist pin during operation of an internal combustion engine.

9. The method as set forth in claim 8 wherein the step of melting the inner periphery of the at least one pin boss includes emitting the laser beam in an axial direction towards the opening of the pin bosses and reflecting the laser beam towards the inner periphery of one of the pin bosses.

10. The method as set forth in claim 9 wherein the piston body is oriented such that the axial direction is in a horizontal plane and the generally circular openings are in a vertical plane and wherein the reflecting step is further defined as reflecting the laser beam in a vertically downward direction such that the portion of the at least one pin boss being melted is a substantially lower-most portion.

11. The method as set forth in claim 10 further including the step of rotating the piston body about the axial direction during the melting of the pin boss.

12. The method as set forth in claim 11 further including a mirror angled at a 45 degree angle relative to the axial direction for reflecting the laser beam towards the inner periphery of the pin boss.

13. The method as set forth in claim 11 wherein the step of rotating the piston body is further defined as rotating the piston body through at least one full rotation to melt substantially the entire inner periphery of the pin boss.

14. The method as set forth in claim 8 further including the step of applying a light absorbing coating to the inner periphery of the at least one pin boss before the step of melting the inner periphery of the pin boss with the laser beam.

15. The method as set forth in claim 14 wherein the light absorbing coating applied to the inner periphery of the at least one pin boss is an ink.

16. The method as set forth in claim 8 wherein the laser beam has a generally rectangular profile and is emitted by a diode laser.

17. An apparatus for hardening an inner diameter of an aluminum or aluminum alloy pin boss in a piston body, comprising:
a rotary chuck for supporting and rotating the piston body;
a laser for emitting a laser beam in a direction towards the pin boss; and
a reflector oriented to reflect the laser beam against the inner diameter of the pin boss to melt at least a portion of the inner diameter of the pin boss during operation of the rotary chuck.

18. The apparatus as set forth in claim 17 wherein said laser is oriented to emit the laser beam in a horizontal direction and wherein said mirror is oriented at a forty-five degree angle relative to said horizontal direction to reflect the laser beam in a vertically downward direction to melt a lower-most portion of the inner diameter of the pin boss.

19. The apparatus as set forth in claim 18 wherein said rotary chuck is oriented to rotate the piston body about an axis extending in the horizontal direction.

20. The apparatus as set forth in claim 17 wherein said laser is a diode laser stack.
